(19) United States
(12) Patent Application Publication
(10) Pub. No.: US 2018/0128639 A1
(43) Pub. Date: May 10, 2018

(54) Method and device system for finding a parked vehicle

(71) Applicant: Bury Sp.z.o.o., Mielec (PL)

(72) Inventor: Jens LEMKE, Lage (DE)

(21) Appl. No.: 15/790,133

(22) Filed: Oct. 23, 2017

(30) Foreign Application Priority Data
Nov. 4, 2016 (DE) 10 2016 121 041.2

(51) Int. Cl. G01C 21/36; H04M 1/725

(52) U.S. Cl. CPC G01C 21/3688; G01C 21/362; H04M 1/7253

(57) ABSTRACT

In order to find a parked vehicle with the aid of a separate navigation device which is independent of the vehicle, a close-range communication connection is established between a vehicle device permanently located in the vehicle and a portable storage device. The communication connection is maintained as long as the storage device is at close range. Collapse of the close-range communication connection between the storage device and the vehicle device is used as the criterion for storing current position data of the vehicle. A navigation device which is in the form of a separate device and contains navigation software and suitable electronic navigation maps, reads out the current position data and is used for navigation to the parked vehicle.

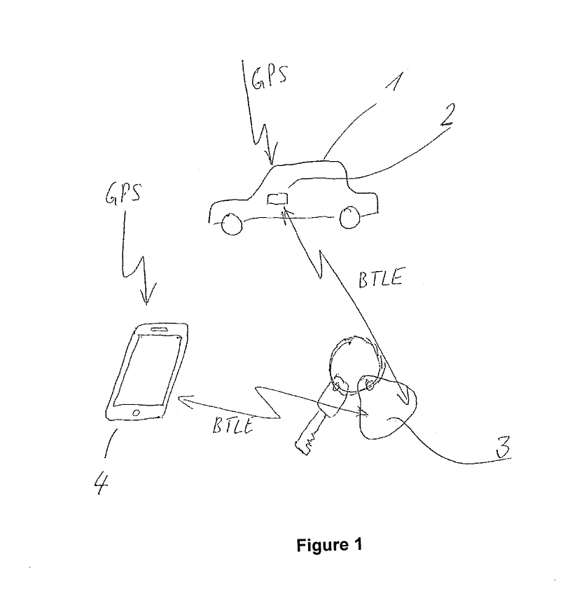

### FIELD OF THE INVENTION

The invention generally relates to a method for finding a parked vehicle with the aid of a separate navigation device which is independent of the vehicle. The invention also generally relates to a device system for finding a parked vehicle for carrying out the method.

### BACKGROUND

The problem of finding a parked vehicle exists in numerous situations in everyday life. This applies, for example, if a driver is not at his destination but rather finds a parking space in an environment further away in a neighborhood not familiar to him and wishes to use the vehicle again after a certain time. In this case, it may take a very long time to find the vehicle again and the driver sometimes requires outside help for this purpose. An app for a smartphone which is in the form of a navigation device with navigation software is known for this situation. If, with the app switched on, a suitable key is pressed upon leaving the vehicle, the smartphone stores the position determined by the navigation software with the aid of an electronic navigation map and therefore makes it possible to display a route to the vehicle from the respective current position. However, if the driver forgets to initialize the storage operation upon leaving the vehicle, it is no longer possible to find the vehicle with the aid of the smartphone.

A far more important need to find a parked vehicle exists when the vehicle is intended to be found by someone who did not himself park this vehicle. This situation occurs both in the case of private vehicles in large parking lots of repair workshops, automobile rental companies, car-sharing vehicles or the like and in the case of professionally used vehicles, such as construction vehicles in a large construction yard or on large construction sites, buses of a large bus company, trucks of a large haulage firm etc. If permanently predefined parking spaces have been set up, they are provided with a corresponding number or address and are communicated to the new driver. This system is cumbersome and fails if no fixed parking spaces are predefined, as may be the case with car-sharing vehicles, for example.

EP 2 088 569 A1 discloses the practice of transmitting information relevant to a parking garage from an infrastructure assigned to a parking space or a group of parking spaces in a parking garage to a suitable portable device by means of near-field communication. For this purpose, the parking garage must be equipped with a complicated infrastructure which, at most, requires a device which is installed in a stationary manner for each parking space.

US 2014/0232569 A1 and US 2014/0232570 A1 disclose the practice of transmitting data from a vehicle device to a mobile device using near-field communication. The vehicle device is intended to use a wide variety of parameters to determine the state of the vehicle, for example whether a driving state, a parked state or an undefined state is present. If a parked state is determined, the location data for the parked state can be transmitted. If necessary, a map for indicating the determined location for the automobile in the parked state may also be transmitted here. In this case, the determination of the parked state by the vehicle device is complicated and susceptible to errors.

### SUMMARY

Therefore, the present invention is based on the object of making it possible to find a parked vehicle in a simple manner without the possibility of forgetting an operation and without a large amount of additional outlay on devices.

In order to achieve this object, the invention provides, in the case of a method of the type mentioned at the outset, for a close-range communication connection to be established between a vehicle device located in the vehicle and a portable storage device and to be maintained as long as the storage device is at close range, for the storage device to be set up to establish a communication connection to the navigation device which is in the form of a separate device and contains navigation software and suitable electronic navigation maps, and for the collapse of the close-range connection between the storage device and the vehicle device to be used as the criterion for storing the current position data, which are used by the navigation device for navigation to the parked vehicle, which is prompted by the storage device. The method according to the invention therefore presupposes a vehicle device which remains in the vehicle and, in particular, can be permanently installed in the vehicle. The vehicle device must be able to establish and maintain a wireless close-range communication connection to the portable storage device. Consequently, in the same manner, the storage device must be suitable for establishing and maintaining the communication connection to the vehicle device. The portable storage device is intended to be worn on the driver's body if the driver leaves the parked vehicle. As a result of the increase in the distance between the vehicle device and the portable storage device, the close range which can be bridged by the communication connection is left, with the result that the connection collapses. This collapse of the connection is detected by the storage device and, in one possibility of possibilities described in more detail below, is used to store the current position data. These stored position data are then used to indicate the route to the parked vehicle from the current location using the navigation device.

The method according to the invention allows numerous embodiment variants. One embodiment which is advantageous in many respects involves the vehicle device continuously generating position data or being connected to a corresponding device in the vehicle. The vehicle device may therefore be, for example, a navigation device which is installed in the vehicle and contains a position data sensor (for example GPS, GLONASS or Galileo sensor). Alternatively, the vehicle device may be connected to a mobile radio device which is connected to a position data sensor in order to be able to make automatic emergency calls in the event of an accident, for example. The vehicle device can continuously transmit the current position data to the storage device as long as the close-range communication connection exists. In this case, the storage device may be set in such a manner that, upon the collapse of the close-range communication connection between the vehicle device and the storage device, position data which were transmitted before the collapse of the close-range connection are stored in a data memory as position data relating to the vehicle. These may be the last complete position data or else position data previously transmitted in a predetermined period. In the latter case, it is possible to take into account the fact that the collapse of the close-range connection can be expected only at a certain distance from the vehicle.

In an alternative embodiment, the storage device itself may be connected to a position data sensor since such position data sensors, for example in the form of GPS chips, are inexpensively available. Upon the collapse of the close-range communication connection, the current position data are stored in the data memory of the storage device.

In yet another embodiment, the storage device can detect the collapse of the communication connection and may have a communication connection to a navigation device. In this case, it suffices if the storage device transmits an initialization signal to the navigation device, with the result that it stores position data determined in the navigation device as vehicle position data. For some application purposes, it is disadvantageous in this solution that the position data relating to the parked vehicle are located only in the navigation device, for example in the form of a smartphone, to which the storage device had a communication connection upon the collapse of the close-range communication connection between the vehicle device and the storage device. In this case, a remedy may involve the navigation device in turn transmitting the vehicle position determined on the basis of the initialization signal to the storage device via the communication connection and the position data being stored there.

In one particularly preferred embodiment of the invention, the storage device is part of the vehicle key or part of a keyring of the vehicle key. This makes it possible to also transfer the position data relating to the vehicle when transferring the vehicle key to the driver.

In principle, the storage device could also be an integral part of a portable navigation device which is used, for example, in rental vehicles without an installed navigation device for navigation in the road traffic and can simultaneously be used for navigation to the parked vehicle. However, a more general range of applications arises if the storage device is in the form of a device which is separate from the navigation device and, as a result, can be created in an inexpensive and simple manner.

The close-range communication connection between the vehicle device and the storage device is, for example, a radio connection according to the Bluetooth standard, preferably according to BTLE (Bluetooth Low Energy). The communication connection between the storage device and the navigation device can be established in the same manner. However, in the case of the last-mentioned connection, it is also possible to establish the latter using a communication cable, for example according to a USB standard. Another variant according to the above statements involves the storage device detecting the collapse of the radio connection to the vehicle device and moreover being an integral part of a portable navigation device.

The vehicle device may be permanently installed in the vehicle, may be plugged into a power supply (cigarette lighter connector) or, in the simplest case, may be supplied with energy using a small battery (button cell), the latter in particular if only the close-range communication connection to the storage device is intended to be established and maintained.

The described invention therefore makes it possible to automatically store position data relating to a parked vehicle if the close-range communication connection to a vehicle device located in the vehicle collapses. The position data relating to the parked vehicle are therefore stored automatically and can be used, if necessary, with a navigation device to mark a route to the parked vehicle from the current position.

### DESCRIPTION OF THE DRAWING

One of the described exemplary embodiments is schematically illustrated in the accompanying drawing.

### DETAILED DESCRIPTION

A vehicle device 2 which is able to receive navigation data, here in the form of GPS data, and to generate position data therefrom is located in a vehicle 1. The vehicle device 2 has a wireless close-range connection BTLE to a storage device 3 which is in the form of a keyring in the exemplary embodiment illustrated. The storage device 3 may in turn have a close-range connection BTLE to a navigation device 4 which, in the exemplary embodiment illustrated, is in the form of a smartphone and is able to carry out navigation with the aid of received navigation data GPS.

As long as the user is located in the vehicle 1, a close-range connection exists between the vehicle device 2 and the storage device 3. Position data generated by the vehicle device are continuously transmitted to the storage device 3 using this connection.

If the user leaves the vehicle, the close-range connection BTLE between the vehicle device 2 and the storage device 3 collapses. The last transmitted position is stored in the storage device 3.

If the vehicle is intended to be found, for example by another user, the latter can use the storage device 3 to establish a close-range connection BTLE to the separate portable navigation device 4 and can transmit the position data stored in the storage device 3 to the navigation device 4. The latter is then able, on account of its navigation equipment, to calculate the route to the location of the stored position data from the current location and to display said route.

When using a storage device 3 integrated in key, it emerges, for vehicles 1 which are equipped with a keyless access system, that the close-range connection BTLE between the vehicle 1 and the storage device 3 required for this purpose can also be used for the purposes according to the invention. In these systems, the close-range connection BTLE already collapses at a distance of a few steps from the vehicle 1, with the result that position data which result from an immediate vicinity of the location of the vehicle 1 are stored.

Although a specific exemplary embodiment has been explained on the basis of the drawing, the invention is not intended to be restricted thereto. The other above-mentioned embodiments and variants can be readily implemented by a person skilled in the art within the scope of the invention.

1. A method for finding a parked vehicle with the aid of a separate navigation device which is independent of the vehicle, comprising:
establishing a close-range communication connection between a vehicle device permanently located in the vehicle and a portable storage device;
maintaining the close-range communication connection between the vehicle device and the portable storage device as long as the storage device is at close range,
wherein the portable storage device is set up to establish a communication connection to the separate navigation device, wherein the separate navigation device contains navigation software and electronic navigation maps;
storing current position data of the parked vehicle upon collapsing the close-range communication connection between the vehicle device and the portable storage device; and
using the stored current position data by the navigation device for navigation to the parked vehicle.

2. The method according to claim 1 wherein the current position data is stored in the portable storage device, and wherein the navigation device reads out the current position data via a communication connection.

3. The method according to claim 1 wherein the current position data of the vehicle is taken from the vehicle device.

4. The method according to claim 3 wherein during the maintaining step the current position data is continuously transmitted from the vehicle device, and wherein upon the collapse of the close-range communication connection between the vehicle device and the portable storage device the current position data which was transmitted before the collapse of the close-range communication connection is stored by the portable storage device as the vehicle position data.

5. The method according to claim 1 wherein upon the collapse of the close-range communication connection between the vehicle device and the portable storage device, an initialization signal for storing the current position data as position data relating to the parked vehicle is transmitted from the storage device to the navigation device.

6. The method according to claim 5, wherein the current position data is at least also stored in the storage device.

7. The method according to claim 6 wherein a wireless communication connection is established between the portable storage device and the navigation device.

8. A system for finding a parked vehicle in accordance with the method according to claim 1, comprising:
a vehicle device positionable in a vehicle;
a storage device which communicates with the vehicle device via a wireless close-range connection;
a navigation device which can be brought into a communication connection with the storage device, wherein the navigation device is in the form of a separate device and contains navigation software and electronic navigation data; and
a detection device associated with the storage device for detecting collapse of the close-range connection to the vehicle device and for initiating a storage operation for current position data.

9. The system according to claim 8, wherein the storage device has a data memory for the current position data.

10. The system according to claim 8 wherein the vehicle device is designed to acquire position data and to transmit the position data to the storage device via the close-range communication connection, and wherein that the storage device is designed to store position data transmitted before the collapse of the close-range communication connection in the data memory as position data relating to the vehicle.

11. The system according to claim 8 wherein the storage device is designed such that, upon the collapse of the close-range communication connection between the vehicle device and the storage device, the current position data is transmitted to the storage device via a communication connection to the navigation device by means of an initialization signal generated by the storage device and is stored in one or more of the navigation device and the data memory.

12. The system according to claim 8 wherein the navigation device is a smartphone with navigation software.

13. The system according to claim 8 wherein the storage device is integrated in an automobile key.

14. The system according to claim 8 wherein the storage device is in the form of a keyring for an automobile key.
